(19) United States
(12) Patent Application Publication
(10) Pub. No.: US 2015/0301239 A1
(43) Pub. Date: Oct. 22, 2015

(54) PIXEL ARRAY

(71) Applicant: Au Optronics Corporation, Hsinchu (TW)

(72) Inventors: Peng-Bo Xi, Taipei City (TW); Ya-Ling Hsu, New Taipei City (TW)

(21) Appl. No.: 14/309,897

(22) Filed: Jun. 20, 2014

(30) Foreign Application Priority Data
Apr. 16, 2014 (TW) 103113895

(51) Int. Cl. G02B 5/20

(52) U.S. Cl. CPC G02B 5/201

(57) ABSTRACT

A pixel array includes a plurality of pixel units. The pixel units are arranged along a first direction and a second direction. Each of the pixel units has a colorless region and a plurality of sub-pixels. The sub-pixels have different colors. Every two adjacent sub-pixels in the first direction have different colors. Every two adjacent sub-pixels in the second direction have different colors as well. The second direction and the first direction are intersected with each other.

### CROSS-REFERENCE TO RELATED APPLICATION

This application claims the priority benefit of Taiwan application serial no. 103113895, filed on Apr. 16, 2014. The entirety of the above-mentioned patent application is hereby incorporated by reference herein and made a part of this specification.

### FIELD OF THE INVENTION

The invention relates to a pixel array; more particularly, the invention relates to a pixel array suitable for being applied to a transparent display.

### DESCRIPTION OF RELATED ART

A transparent display is a display characterized by a certain degree of transmittance and capable of clearly displaying the background behind the display panel. The transparent display is applicable to windows of buildings, windshields and other car windows, shop display windows, and so on. Since the transparent display is not only able to display the background behind the display panel but also likely to act as an information display in the near future, the transparent display has attracted great attention.

To achieve colorful display effects, the pixel array of the transparent display includes a plurality of pixel units, each of which includes a plurality of sub-pixels of different colors. Specifically, the sub-pixels may include a red sub-pixel, a blue sub-pixel, and a green sub-pixel sequentially arranged along a first direction. The pixel units are arranged along the first direction and a second direction, and the first direction and the second direction are perpendicular to each other, for instance. Thereby, the sub-pixels successively arranged along the first direction have different colors (e.g., red, blue, and green in order), while the sub-pixels successively arranged along the second direction have the same colors (e.g., all in red, blue, or green). If the transparent display displays images, and the borders of the images in the display frame are parallel to the second direction in which the sub-pixels of the same color are arranged, it is rather difficult to clearly display the borders of the images. Accordingly, the blurred borders of the images deteriorate the display quality of the transparent display.

### SUMMARY OF THE INVENTION

The invention is directed to a pixel array that includes a plurality of pixel units, and colorless regions and sub-pixels of different colors in each pixel unit are arranged in a specific manner, so as to ensure the favorable display quality.

In an embodiment of the invention, a pixel array includes a plurality of pixel units. The pixel units are arranged along a first direction and a second direction. Each of the pixel units has a colorless region and a plurality of sub-pixels. The sub-pixels have different colors. Every two adjacent sub-pixels in the first direction have different colors. Every two adjacent sub-pixels in the second direction have different colors. The second direction and the first direction are intersected with each other.

In view of the above, the pixel array described herein includes plural pixel units, each of which includes a colorless region and a plurality of sub-pixels of different colors. Since every two adjacent sub-pixels arranged along the first direction and the second direction have different colors, the borders of the images can be clearly displayed on the frame, and thus the use of the pixel array described herein ensures the favorable display quality.

Several exemplary embodiments accompanied with figures are described in detail below to further describe the invention in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a schematic diagram illustrating an arrangement of a pixel array according to a first embodiment of the invention.

FIG. 2 is a schematic diagram illustrating an arrangement of a pixel array according to a second embodiment of the invention.

FIG. 3 is a schematic diagram illustrating an arrangement of a pixel array according to a third embodiment of the invention.

FIG. 4 is a schematic diagram illustrating an arrangement of a pixel array according to a fourth embodiment of the invention.

FIG. 5 is a schematic diagram illustrating an arrangement of a pixel array according to a fifth embodiment of the invention.

FIG. 6 is a schematic diagram illustrating an arrangement of a pixel array according to a sixth embodiment of the invention.

FIG. 7 is a schematic diagram illustrating an arrangement of a pixel array according to a seventh embodiment of the invention.

### DETAILED DESCRIPTION OF DISCLOSED EMBODIMENTS

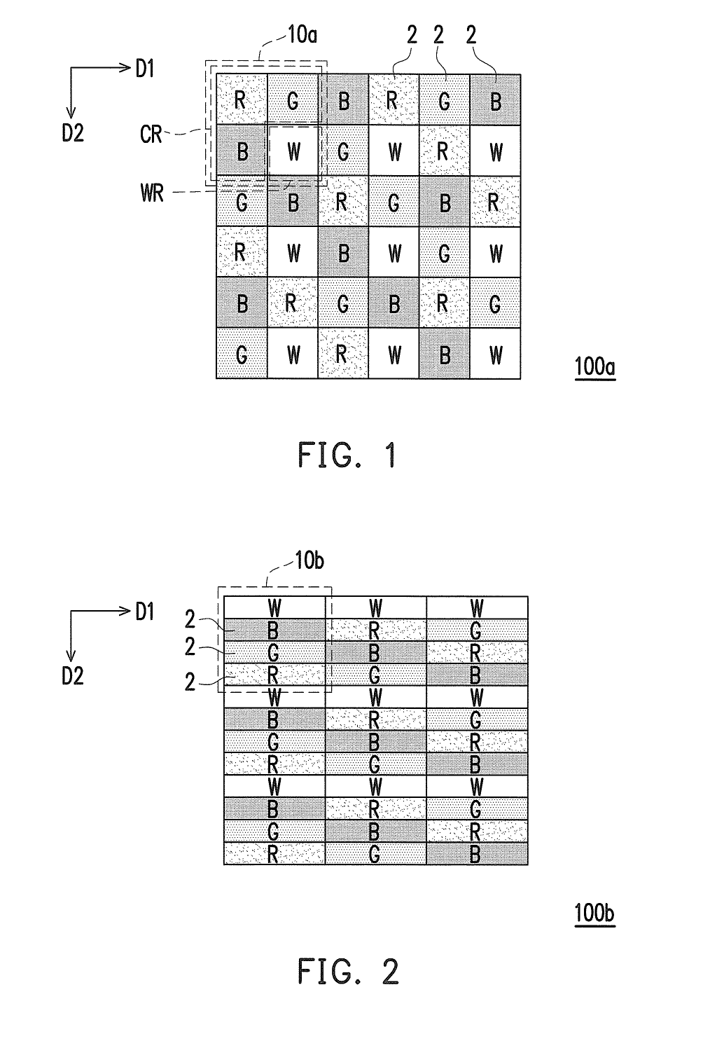

FIG. 1 is a schematic diagram illustrating an arrangement of a pixel array according to a first embodiment of the invention. With reference to FIG. 1, the pixel array 100a includes a plurality of pixel units 10a. Each of the pixel units 10a includes a colorless region WR and a plurality of sub-pixels 2. The sub-pixels 2 may have different colors and are not colorless sub-pixels. That is, the sub-pixels 2 are neither transparent nor white, and the area where the sub-pixels 2 are distributed has color resist for displaying different colors. The sub-pixels 2 may be adjacent to each other or one another.

The colorless region WR may be a region where no resist is configured, and light is allowed to pass through the colorless region WR; alternatively, transparent resist may be configured in the colorless region WR, and the colorless region WR can thus have the high light transmittance. In the present embodiment, the colorless region WR includes one colorless sub-region W, and the shape and the size of the colorless sub-region W are the same as those of the sub-pixels 2. The colorless region WR includes one colorless sub-region W in the present embodiment, while the invention is not limited thereto. According to another embodiment of the invention, the colorless region WR may include a plurality of colorless sub-regions W. In light of the above, each pixel unit 10a described herein may include a color region CR and the colorless region WR. The color region CR may be constituted by plural sub-pixels 2 for displaying colors, while the colorless region WR may enhance the light transmittance of each pixel unit 10a, so as to improve the overall transparency of the pixel units 10a. Thereby, the pixel array 100a is suitable for being applied in a transparent display.

In particular, each pixel array 10a may include three sub-pixels 2, e.g., a first sub-pixel R, a second sub-pixel G, and a third sub-pixel B. Here, the first sub-pixel R is red, the second sub-pixel G is green, and the third sub-pixel B is blue, for instance. Color lights of the first sub-pixel R, the second sub-pixel G, and the third sub-pixel B in each of the pixel units 10a are mixed to generate white light. In other embodiments of the invention, the first sub-pixel R, the second sub-pixel G, and the third sub-pixel B may have other colors, and the number of the sub-pixels in each pixel unit 10a may be two, four, or more, given that the color lights of the sub-pixels 2 in each of the pixel units 10a can be mixed to generate the required white light.

According to the present embodiment, the pixel units 10a in the pixel array 100a are arranged along a first direction D1 and a second direction D2, and the first direction D1 and the second direction D2 are intersected with each other. In the present embodiment, the first direction D1 and the second direction D2 are, for instance, perpendicular to each other, but the invention is not limited thereto. Every two adjacent sub-pixels 2 in the first direction D1 have different colors, and every two adjacent sub-pixels 2 of the sub-pixels in the second direction D2 have different colors. Specifically, each of the sub-pixels 2 described herein is shaped as a rectangle, and the term of “two adjacent sub-pixels 2” means that the sides of two sub-pixels 2 are adjoined to each other. As shown in FIG. 1, in one of the pixel units 10a, the sides of the first and second sub-pixels R and G are adjoined to each other, and thus the first sub-pixel R in one of the pixel units 10a is adjacent to the second sub-pixel G in the same pixel unit 10a. Similarly, the sides of the first and third sub-pixels R and B are adjoined to each other, and thus the first sub-pixel R in one of the pixel units 10a is adjacent to the third sub-pixel B in the same pixel unit 10a. However, the side of the first sub-pixel R is not adjoined to the side of the colorless sub-region W, and thus the first sub-pixel R in one of the pixel units 10a is not adjacent to the colorless sub-region W in the same pixel unit 10a.

In the present embodiment, the first sub-pixel R, the second sub-pixel G, and the third sub-pixel B have different colors, respectively; therefore, in the pixel array 100a described in the present embodiment, every two adjacent sub-pixels 2 in the first direction D1 have different colors, and every two adjacent sub-pixels 2 in the second direction D2 have different colors. Particularly, every three successive sub-pixels 2 in the first direction D1 have different colors, and every three successive sub-pixels 2 in the second direction D2 have different colors. Here, the term of “three successive sub-pixels” refers to three sub-pixels that are successively arranged, and the three sub-pixels do not include the colorless sub-region. Therefore, the three successive sub-pixels are not required to be adjacent sub-pixels. For instance, the “three successive sub-pixels” may be or may not be adjacent sub-pixels. As shown in FIG. 1, the three successive sub-pixels 2 in the first direction D1 in the first row are adjacent sub-pixels 2. However, in the second row, the colorless sub-regions W are respectively located among the three successive sub-pixels 2 in the first direction D1. Similarly, the three successive sub-pixels 2 of different colors in the second direction D2 in the first column are adjacent sub-pixels 2. Nevertheless, in the second column, the colorless sub-regions W are respectively located among the three successive sub-pixels 2 in the second direction D2. That is, the three successive sub-pixels 2 along the first and second directions D1 and D2 may have different colors according to the present embodiment. Thereby, when the pixel array 100a is applied to a display panel for displaying images, the borders of the images in the display frame can be clearly displayed, and thus no blurred borders of the images deteriorate the display quality of the transparent display.

According to the present embodiment, each pixel unit 10a merely includes one colorless sub-region W, and the colorless sub-regions W of every two adjacent pixel units 10a are not adjacent to each other. Specifically, the term of “two adjacent pixel units 10a” means that the sides of two pixel units 10a are adjoined to each other. If the two colorless sub-regions W are not adjacent to each other, it indicates that the sides of the two colorless sub-regions W are not adjoined to each other. In the present embodiment, each pixel unit 10a includes three sub-pixels 2 and one colorless sub-region W which are arranged in a checker-board manner, and the sub-pixels 2 and the colorless sub-region W are respectively shaped as a square, for instance. The colorless sub-region W is located at the lower-right corner in each pixel unit 10a, and thus the colorless sub-regions W of every two adjacent pixel units 10a are not adjacent to each other. Since the pixel array 100a includes plural colorless sub-region W, the pixel array 100a applied to the transparent display allows the light transmittance to be raised and enhances the transparency, such that the user may experience the improved perception of transparency.

In the present embodiment, the sub-pixels 2 and the colorless sub-region W in one pixel unit 10a may be arranged in a manner different from that of the sub-pixels 2 and the colorless sub-region W in the adjacent pixel unit 10a. For instance, in the upper-left pixel unit 10a, the first sub-pixel R, the second sub-pixel G, the third sub-pixel B, and the colorless sub-region W are arranged from left to right and from top to bottom; in the upper-right pixel unit 10a, the second sub-pixel G, the third sub-pixel B, the first sub-pixel R, and the colorless sub-region W are arranged from left to right and from top to bottom; in the pixel unit 10a between the upper-left pixel unit 10a and the upper-right pixel unit 10a, the third sub-pixel B, the first sub-pixel R, the second sub-pixel G, and the colorless sub-region W are arranged from left to right and from top to bottom. Said arrangements are merely exemplary and should not be construed as limitations to the invention.

Several embodiments are provided hereinafter to elaborate the invention; here, the same components may share the same reference numbers, and the same technical descriptions will not be further repeated. FIG. 2 is a schematic diagram illustrating an arrangement of a pixel array according to a second embodiment of the invention. With reference to FIG. 2, the pixel array 100b includes a plurality of pixel units 10b. Each of the pixel units 10b includes a color region and a colorless region, the color region includes a plurality of sub-pixels 2, and the colorless region includes one colorless sub-region W.

In the pixel array 100b, three successive sub-pixels 2 along the first direction D1 have different colors. In the present embodiment, the three successive sub-pixels 2 of different colors may be adjacent sub-pixels 2. By contrast, three successive sub-pixels 2 along the second direction D2 have different colors, and the three successive sub-pixels 2 of different colors may be adjacent sub-pixels 2 or may not be adjacent sub-pixels 2. For instance, in three exemplary pixel units 10b arranged along the first direction D1, the three successive sub-pixels 2 in the first direction D1 in the second row are sequentially the third sub-pixel B, the first sub-pixel R, and the second sub-pixel G, and thus the three successive sub-pixels 2 have different colors. Similarly, the three successive sub-pixels 2 in the first direction D1 in the third row are sequentially the second sub-pixel G, the third sub-pixel B, and the first sub-pixel R, and thus the three successive sub-pixels 2 have different colors. For instance, in three exemplary pixel units 10b arranged along the second direction D2, the three successive sub-pixels 2 in the second direction D2 in the first column are sequentially the third sub-pixel B, the second sub-pixel G, and the first sub-pixel R, and thus the three successive sub-pixels 2 of different colors may be adjacent sub-pixels. However, the term of “three successive sub-pixels 2” herein excludes the colorless sub-region W; thus, the colorless sub-region W may be arranged between any two of the three successive sub-pixels 2, and the three successive sub-pixels 2 may not be adjacent sub-pixels. For instance, the sub-pixels 2 in the third row to the sixth row in the first column are sequentially the second sub-pixel G, the first sub-pixel R, the colorless sub-region W, and the third sub-pixel B; according to such arrangement, the three successive sub-pixels 2 are deemed to have different colors.

To be specific, each pixel unit 10b includes one colorless sub-region W, and the colorless sub-regions W of every two adjacent pixel units 10b are adjacent to each other. According to the present embodiment, the shapes and the sizes of the sub-pixels 2 and the colorless sub-region W are the same, the sub-pixels 2 and the colorless sub-region W are respectively shaped as a rectangle (e.g., an oblong) at least having one long side and one short side. In the present embodiment, the adjacent colorless sub-regions W are arranged along the first direction D1, and the first direction D1 is parallel to a long-side direction of each of the sub-pixels 2. Besides, the first sub-pixel R, the second sub-pixel G, the third sub-pixel B, and the colorless sub-region W in each pixel unit 10b are arranged along the second direction D2.

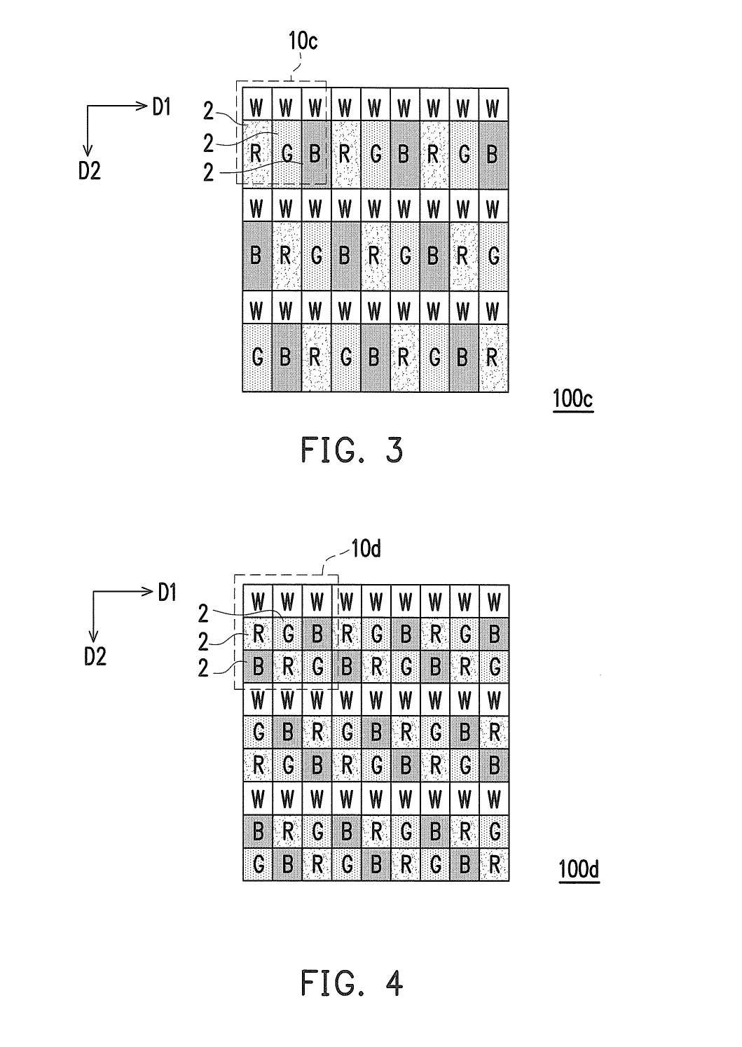

FIG. 3 is a schematic diagram illustrating an arrangement of a pixel array according to a third embodiment of the invention. With reference to FIG. 3, in the previous embodiments, each pixel unit 10a and each pixel unit 10b respectively have one colorless sub-region W; however, the invention is not limited thereto. The colorless region of each of the pixel units 10c provided in the present embodiment includes a plurality of colorless sub-regions W, e.g., three colorless sub-regions W. According to other embodiments of the invention, the colorless region may include two, four, or more colorless sub-regions W. Each pixel unit 10c described herein includes three sub-pixels 2, and the number of the colorless sub-regions W is the same as the number of the sub-pixels 2.

According to the present embodiment, three successive sub-pixels 2 along the first direction D2 have different colors, and the three successive sub-pixels 2 of different colors may be adjacent sub-pixels 2. By contrast, three successive sub-pixels 2 along the second direction D2 have different colors, and the three successive sub-pixels 2 of different colors may not be adjacent sub-pixels 2. In addition, the colorless sub-regions W of every two adjacent pixel units 10c are adjacent colorless sub-regions W arranged along the first direction D1, for instance, and the sub-pixels 2 and the colorless sub-regions W are alternately arranged along the second direction D2. Besides, according to the previous embodiments, the sizes of the sub-pixels 2 and the sizes of the colorless sub-regions W are the same, which should however not be construed as a limitation to the invention. In the present embodiment, the sizes of the sub-pixels 2 may be greater than the sizes of the colorless sub-regions W.

FIG. 4 is a schematic diagram illustrating an arrangement of a pixel array according to a fourth embodiment of the invention. With reference to FIG. 4, the pixel array 100d described herein is similar to the pixel array 100c depicted in FIG. 3, while the difference therebetween lies in that the number of the sub-pixels in each pixel unit 10d of the pixel array 100d is twice the number of the colorless sub-regions W, and the sizes and the shapes of the sub-pixels 2 are the same as those of the colorless sub-regions W. In the present embodiment, each of the pixel units 10d includes six sub-pixels 2 and three colorless sub-regions W. Note that the number of the sub-pixels 2 and the number of the colorless sub-regions W are not limited in the invention.

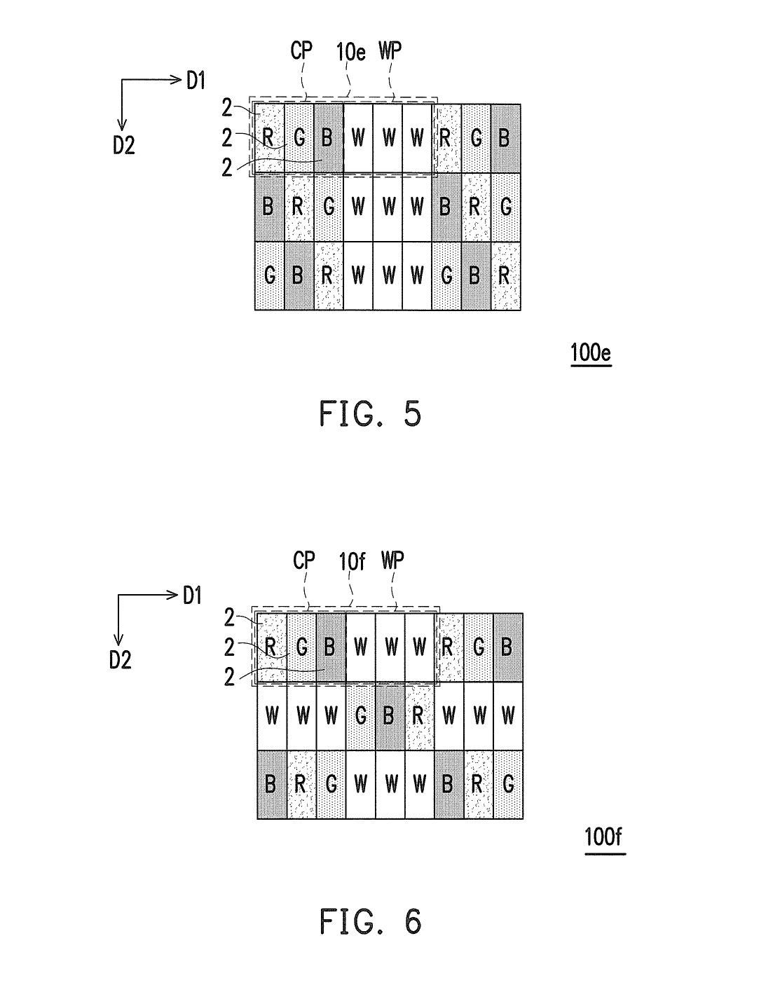

FIG. 5 is a schematic diagram illustrating an arrangement of a pixel array according to a fifth embodiment of the invention. With reference to FIG. 5, the pixel array 100e includes a plurality of pixel units 10e. The number of the sub-pixels 2 in each pixel unit 10e is the same as the number of the colorless sub-regions W in the colorless region. The sub-pixels 2 are adjacent to form a color pixel CP, and the colorless sub-regions W are adjacent to form a colorless pixel WP. The pixel array 100e may include a plurality of the color pixels CP and a plurality of the colorless pixels WP. From another perspective, each pixel unit 10e includes a color pixel CP and a colorless pixel WP, and where the colorless pixel WP is located is where the colorless region is located. The color pixel CP and the colorless pixel WP are adjacent to each other. The colorless pixel WP (e.g., equivalent to the colorless region) includes three adjacent colorless sub-regions W, and the color pixel CP includes three adjacent sub-pixels 2 of different colors. The colorless pixels WP are arranged in an adjacent manner along the second direction D2. The color pixels CP are arranged in an adjacent manner along the second direction D2. The color pixels CP and the colorless pixels WP are alternately arranged along the first direction D1.

FIG. 6 is a schematic diagram illustrating an arrangement of a pixel array according to a sixth embodiment of the invention. With reference to FIG. 6, the pixel array 100f described herein is similar to the pixel array 100e depicted in FIG. 5, while the difference therebetween lies in that the color pixels CP and the colorless pixels WP in the pixel array 100f are alternately arranged along the first direction D1, and the color pixels CP and the colorless pixels WP in the pixel array 100f are also alternately arranged along the second direction D2.

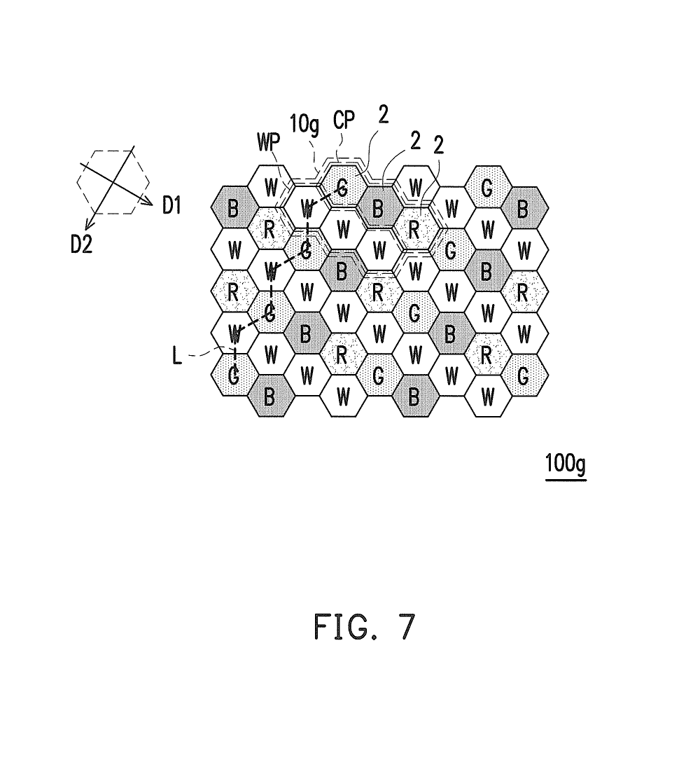

FIG. 7 is a schematic diagram illustrating an arrangement of a pixel array according to a seventh embodiment of the invention. With reference to FIG. 7, the pixel array 100g includes a plurality of pixel units 10g. The number of the sub-pixels 2 in each pixel unit 10g is the same as the number of the colorless sub-regions W. The sub-pixels 2 are adjacent to form a color pixel CP, and the colorless sub-regions W are adjacent to form a colorless pixel WP (e.g., equivalent to the colorless region). The pixel array 100g may include a plurality of the color pixels CP and a plurality of the colorless pixels WP. From another perspective, each pixel unit 10g includes a color pixel CP and a colorless pixel WP. The color pixel CP and the colorless pixel WP are adjacent to each other. The colorless pixel WP includes three adjacent colorless sub-regions W, and the color pixel CP includes three adjacent sub-pixels 2 of different colors. The colorless pixels WP are arranged in an adjacent manner along the first direction D1. The color pixels CP and the colorless pixels WP are alternately arranged along a zigzag path L in the second direction D2. In the present embodiment, each of the sub-pixels 2 is shaped as a regular hexagon, and each of the colorless regions W is shaped as a regular hexagon as well.

Each of the pixel arrays 100a to 100g may be selectively applied in the transparent display, and the transparent display may be a non-self-illuminating display or a self-illuminating display. For instance, the transparent display may be a liquid crystal display or an organic electroluminescent display, which should however not be construed as a limitation to the invention.

To sum up, the pixel array described herein includes plural pixel units, each of which includes at least one colorless region and a plurality of sub-pixels of different colors. Since every two adjacent sub-pixels arranged along the first direction and the second direction have different colors, the borders of the images can be clearly displayed on the frame, and thus the use of the pixel array described herein ensures the favorable display quality.

What is claimed is:

1. A pixel array comprising:
a plurality of pixel units arranged along a first direction and a second direction, each of the pixel units having a colorless region and a plurality of sub-pixels, the sub-pixels having different colors,
wherein every two adjacent sub-pixels of the sub-pixels in the first direction have different colors, every two adjacent sub-pixels of the sub-pixels in the second direction have different colors, and the first direction and the second direction are intersected with each other.

2. The pixel array as recited in claim 1, wherein the sub-pixels are not colorless.

3. The pixel array as recited in claim 1, wherein color lights of the sub-pixels in each of the pixel units are mixed to generate white light.

4. The pixel array as recited in claim 1, wherein successive sub-pixels of the sub-pixels in the first direction have different colors, and successive sub-pixels of the sub-pixels in the second direction have different colors.

5. The pixel array as recited in claim 1, wherein the colorless region of each of the pixel units comprises one colorless sub-region, and the colorless sub-regions of every two adjacent pixel units of the pixel units are not adjacent to each other.

6. The pixel array as recited in claim 1, wherein the colorless region of each of the pixel units comprises one colorless sub-region, and the colorless sub-regions of every two adjacent pixel units of the pixel units are adjacent to each other.

7. The pixel array as recited in claim 6, wherein the adjacent colorless sub-regions are arranged along the first direction, and the first direction is a long-side direction of each of the sub-pixels.

8. The pixel array as recited in claim 6, wherein the colorless region and the sub-pixels are arranged along the second direction in each of the pixel units.

9. The pixel array as recited in claim 1, wherein the colorless region of each of the pixel units comprises a plurality of adjacent colorless sub-regions, and the colorless sub-regions of every two adjacent pixel units of the pixel units are adjacent colorless sub-regions.

10. The pixel array as recited in claim 9, wherein the adjacent colorless sub-regions are arranged along the first direction.

11. The pixel array as recited in claim 1, wherein the colorless region of each of the pixel units comprises a plurality of colorless sub-regions, and the number of the sub-pixels in each of the pixel units is a multiple of the number of the colorless sub-regions in each of the pixel units.

12. The pixel array as recited in claim 1, wherein the colorless region comprises a plurality of adjacent colorless sub-regions, the number of the sub-pixels in each of the pixel units is the same as the number of the colorless sub-regions in each of the pixel units.

13. The pixel array as recited in claim 1, wherein the sub-pixels are adjacent to form a color pixel, and the colorless region is configured to form a colorless pixel, such that the plurality of pixel units comprise a plurality of the color pixels and a plurality of the colorless pixels.

14. The pixel array as recited in claim 13, wherein the color pixels and the colorless pixels are alternately arranged along the first direction, and the colorless pixels are arranged in an adjacent manner along the second direction.

15. The pixel array as recited in claim 13, wherein the color pixels and the colorless pixels are alternately arranged along the first direction and the second direction.

16. The pixel array as recited in claim 13, wherein the color pixels and the colorless pixels are alternately arranged along a zigzag path in the second direction, and the colorless pixels are arranged in an adjacent manner along the first direction.

17. The pixel array as recited in claim 1, wherein the colorless region of each of the pixel units comprises at least one colorless sub-region, each of the sub-pixels is shaped as a regular hexagon, and each of the at least one colorless region is shaped as a regular hexagon.

18. The pixel array as recited in claim 1, wherein the colorless region of each of the pixel units comprises at least one colorless sub-region, each of the sub-pixels is shaped as a rectangle, and each of the at least one colorless region is shaped as a rectangle.
